(19) United States
(12) Patent Application Publication
(10) Pub. No.: US 2011/0031711 A1
(43) Pub. Date: Feb. 10, 2011

(54) Scooter

(75) Inventor: Martin Grossman, Glasgow (GB)

Correspondence Address: OWENS TARABICHI LLP, 111 N. Market St., Suite 730, SAN JOSE, CA, 95113, US

(73) Assignee: H GROSSMAN LTD, Rutherglen, Glasgow (GB)

(21) Appl. No.: 12/864,629

(22) PCT Filed: Jan. 28, 2009
(86) PCT No.: PCT/GB09/00223

§ 371 Date: Oct. 26, 2010

(30) Foreign Application Priority Data
Jan. 30, 2008 (GB) GB 0801630.5

(51) Int. Cl. B62M 1/00; A63C 17/01; B60Q 1/00

(52) U.S. Cl. 280/87.041; 280/87.042; 315/77

(57) ABSTRACT

A self-propelled vehicle comprising a scooter (10; 10a; 10b), which comprises at least one illumination means (16; 16a; 16b) and switch means (10; 100a; 100b) for controlling the at least one illumination means (16; 16a; 16b), wherein the switch means (100; 100a; 100b) is audio or acoustically activated, such as, by an ambient voice, vocal or musical signal. The switch means (100; 100a; 100b) comprises an audio detection means (105; 105a; 105b) optionally provided on or under a platform (12; 12a; 12b) of the scooter (10; 10a; 10b). The illumination means (16; 16a; 16b) are provided on the platform (12; 12a; 12b). There is also optionally provided at least one audio device (150b), such as a digital audio file player which can be detachably attached to the scooter (10b), e.g. handlebars (130b) thereof.

### FIELD OF INVENTION

The present invention relates to an improved scooter or similar type of self-propelled or foot-propelled vehicle or transport means. The invention particularly, though not exclusively, relates to a scooter, such as a collapsible scooter, “microscooter” or the like, incorporating a novel or novelty illumination or lighting effect.

### BACKGROUND OF INVENTION

Scooters have undergone an upsurge in popularity in recent years, e.g. because of innovations such as folding scooters or “microscooters”.

It is an object of at least one embodiment of at least one aspect of the present invention to obviate and/or mitigate one or more problems/disadvantages in the prior art.

It is an object of at least one embodiment of at least one aspect of the present invention to provide an improved scooter incorporating a novel or novelty effect, particularly a novel or novelty lighting and/or acoustic effect.

It is an object of at least one embodiment of at least one aspect of the present invention to provide an improved self-propelled or foot-propelled vehicle or transport means or scooter, which is more attractive for use by children or infants and/or which provides additional safety benefits.

### SUMMARY OF INVENTION

One or more objects of the invention are sought to be at least partially addressed or fulfilled by providing the general solution of a vehicle, such as scooter, comprising audio or acoustically operated switch means for controlling illumination means.

According to a first aspect of the present invention there is provided a scooter or self-propelled or foot-propelled vehicle or transport means, such as a scooter, comprising at least one illumination means and a switch means for controlling the at least one illumination means, wherein the switch means is audio or acoustically operated or activated.

Herein by audio or acoustically is particularly meant sound or sounds, e.g. which can be heard by the human ear. The vehicle or scooter may therefore be said to have “sound activated lights”.

This arrangement has been found to be particularly advantageous in that it provides a novel sound activated lighting effect. This is desirable for use by children and provides additional safety, in use.

The switch means may also be audio or acoustically deactivated.

The vehicle or scooter may comprise handlebars and/or a steering column.

Preferably, the scooter or self-propelled or foot-propelled vehicle or transport means may be a scooter. Most preferably, the scooter is a so-called “microscooter”. Preferably, the scooter or vehicle may be collapsible or foldable.

The scooter or vehicle may be adapted for use by children or infants.

Alternatively, the scooter or self-propelled or foot-propelled vehicle or transport means may be a skateboard. The skateboard may be a training skateboard provided with a handle, which handle may be collapsible.

Preferably the switch means may be activated by an audio or acoustic input or signal, such as an ambient voice, vocal or preferably musical signal.

Alternatively the audio signal may be caused by striking or impacting at least a portion of the vehicle. However, it will be appreciated that in such implementation the switch means may be operated or activated by a sound or sounds produced by the impact and not by impact or any associated vibration per se.

In use, the switch means and/or the illumination means may be activated only for as long as the audio input or signal lasts.

The switch means may switch on and off when the audio or input or signal stops.

The switch means may switch the illumination means on and off in time with or synchronised with the audio input or signal, e.g. in time with the voice, vocal or music signal.

Alternatively, upon activation the scooter may provide means for operating the switch means and/or the illumination means for a predetermined length of time. Subsequent to the predetermined length of time the switch means and/or the illumination means may be deactivated.

The switch means may comprise an audio detection means or microphone. The switch means may also comprise a switch element or elements controlled by the audio detection means.

The vehicle or scooter may comprise a platform or deck, e.g. for supporting a user, e.g. for use as a footplate for a user.

The audio detection means may be located or positioned at or on a/the platform or deck of the vehicle or scooter.

Most preferably, the audio detection means may be located or positioned below the platform or deck of the vehicle or scooter, e.g. between elongate sides or edge of the deck. This has surprisingly been found to be a particularly advantageous configuration. For example, the audio detection means may be protected from damage.

The audio detection means may be located or positioned on or in a control box or an enclosure.

The audio detection means may be provided on an end of the control box or enclosure, e.g. on a front end thereof. The switch element or elements may be provided within the control box or enclosure.

The switch means may also comprise a switch member.

The switch member may be provided on the platform or deck, e.g. at a forward end thereof.

The switch member may have an off position wherein the audio detection means is off.

The switch member may have a first on position wherein the audio detection means is on, and wherein the at least illumination means may be controlled thereby (as hereinbefore described).

The switch member may have a second on position wherein the illumination means is illuminated in a predetermined manner, e.g. intermittently or continuously, e.g. under control of control circuitry, and independent of the audio detection means.

The platform may provide the illumination means. The platform may have the illumination means at least visible on an upper surface thereof.

Alternatively or additionally the platform may have the illumination means along a side edge(s) thereof.

The illumination means may comprise or incorporate a novelty lighting effect.

Provision of an at least one illumination means or novelty lighting effect on the scooter may, when illuminated, make the scooter more visible to onlookers and/or passers-by and/or to a user. Making a scooter more visible can assist in avoiding and/or reducing accidents involving scooters, and/or can provide an additional visual effect such as a novelty visual effect, e.g. when the rider is performing stunts or maneuvers.

The platform or deck may be at least part transparent or translucent. Provision of an at least part transparent or translucent platform or deck may permit effects, such as novelty lighting effects, to be incorporated within or adjacent to the platform or deck whilst still being visible.

Preferably, at least part, e.g. a lower part, of the platform may comprise a metal or a metallic material and may be extruded.

Where metal is used the metal may be substantially aluminium or an alloy thereof.

Advantageously alternatively or additionally, at least part (e.g. an upper part) of the platform may comprise a polymeric or plastics material. Where at least a part of the platform comprises a polymeric or plastics material, preferably the plastics material may be a thermoplastic such as ABS. A thermoplastic platform, such as ABS, is suitable for high volume moulding processes such as injection moulding.

Using injection moulding to manufacture a polymeric or plastics platform part or extrusion to manufacture a metal platform part allows at least part of the platform to be manufactured as a unitary component, thereby potentially increasing the strength of the platform and reducing the cost of manufacture of the platform.

Most preferably, the platform comprises a first portion, preferably made from a metal or metallic material, and a second portion, e.g. which is at least part transparent or translucent, preferably made from a polymeric or plastics material.

The platform may further include end caps. The end caps may be used to secure the first and second portions together.

Preferably, the illumination means are provided on, in and/or along, and/or below, adjacent and/or in association with the platform.

In use, light may pass through the second portion of the platform and/or pass therethrough and/or reflect off inner surfaces, e.g. sidewalls, thereof. The illumination means may therefore provide a pseudo “disco” floor effect.

Preferably, the at least part transparent or translucent second portion of the platform permits light from the illumination means to pass through at least part of a top surface of the platform.

The transparent or translucent portion of the platform may be translucent. Alternatively, the transparent or translucent portion of the platform may be transparent. Where the transparent or translucent part of the platform is translucent, this may give rise to a “milky” effect. A “milky” effect may diffuse the light effect created by the illumination means.

Preferably, the illumination means comprises at least one and preferably a plurality of light sources, e.g. light emitting diodes (LEDs). LEDs are preferred as LEDs use relatively low levels of power whilst providing a desired visual effect.

The illumination means may be provided in a plurality of different colours. Preferably, the illumination means are selected from one or more of the following colours: red, blue, green, yellow, white, purple, pink, gold, turquoise, orange.

Most preferably, the LEDs are surface mounted display LEDs. Where surface mounted display LEDs are used, preferably, such are mounted on a printed circuit board (PCB).

Preferably, the PCB is located between the first and second portions of the platform.

Alternatively, the PCB is located on at least part of an upper surface of the platform.

Preferably, the PCB is secured to or within the platform of the scooter or self-propelled or foot-propelled vehicle or transport means. The PCB may be secured to or within the platform of the scooter or self-propelled vehicle or foot-propelled vehicle or transport means by securing means such as glue, rivets, screws or any other suitable securing means.

The PCB may be covered in a coating such as epoxy, e.g. an epoxy resin. The coating, such as epoxy, may be provided to protect the PCB; however, such may be arranged such that the LEDs are still visible.

Alternatively or additionally, the PCB may be covered by opaque, translucent or apertured means, paper or card, and may be arranged such that the light from the illumination means passes through the opaque, translucent or apertured means, paper or card or is visible through apertures in the opaque, translucent or apertured means, paper or card.

Preferably, the transparent or translucent part of the platform covers and/or protects the LEDs.

Preferably, the transparent or translucent part of the platform may comprise a polymeric or plastics material.

The second portion (e.g. transparent or translucent portion) of the platform may wrap around or extend to cover one or more of the edges of the first portion of the platform.

The illumination means may be provided/further provided along at least first and second regions of the platform. Preferably, the first and second regions of the platform may be adjacent first and second sides or side edges of the platform. Preferably, in use, a user may place his or her foot between said first and second regions.

The illumination means may define a closed shape upon a portion or footplate of the platform, e.g. defining where a user should place a foot, in use. Providing guidance for a user as to where to place a foot on the platform can assist the user in selecting optimum placement of their foot to ride upon the scooter or vehicle and/or to execute a manoeuvre.

Preferably, the scooter or other self-propelled or foot-propelled vehicle or transport means may comprise control means for the user to select a desired operation mode of the illumination means.

It is preferred that alternative visual effects of the illumination means may be selected and controlled by the control means.

Preferably, the control means comprises the switch means. The control means may be programmed to operate in a number of modes such as off, sound/acoustic activated, and on, e.g. optionally continuous, flashing, strobing, chaser, etc.

Preferably, the illumination means is powered by one or more batteries. Alternatively, the scooter comprises a power generator, such as a dynamo for powering the illumination means.

The control means may further comprise a vibration operated switch. A vibration operated switch may react to vibrations passing through the scooter, for example, as the scooter passes over a rough surface, or when the scooter receives an impact such as a user's foot landing on the platform, or when the scooter is struck, e.g. off a surface, e.g. the ground, so as to activate the illumination means.

Alternatively or additionally, the control means may comprise a weight sensor. A weight sensor may react to a user standing on the scooter to activate the illumination means.

Once activated the illumination means may illuminate for a fixed period of time, for example, 5 seconds. The illumination means may, therefore, continue to operate for a period after movement ceases.

Preferably, at least part of the circuitry of the PCB is located at one end of the PCB. Where the scooter is a collapsible scooter or microscooter, preferably, part of the circuitry of the PCB is located adjacent a hinge of the scooter. It has been found that the hinge provides useful additional protection for the circuitry.

Preferably, the scooter or other self-propelled or foot-propelled vehicle or transport means may be a scooter, most preferably a two wheeled scooter or alternatively a three wheeled scooter, e.g. having a single front wheel and two rear wheels. In the latter case the rear wheels may be co-axial with one another.

There may be provided means for spacing the first portion from the second portion.

The spacing means may comprise a plurality of pillars extending from the second portion and beneficially integrally formed therewith.

The vehicle or scooter may have at least one illumination means, the illumination means being operable in response to a vibration or impact applied to the scooter or vehicle.

A vibration or impact can be a single or repetitive force applied to the scooter or the like, e.g. as the scooter travels over a surface, or it could be a single impact caused by the scooter landing on a surface after a manoeuvre has been performed, or an impact caused by a user mounting or striking the scooter or striking the scooter off a surface or other body.

The scooter may have a rear brake.

The rear brake may comprise a brake member resiliently biased into a first position away from the rear wheel(s). Application of a force, e.g. from a foot of a user, may cause at least a portion(s) of the brake member to frictionally engage the rear wheel(s).

The illumination means or novelty lighting effect may be provided or further provided on handlebars of the vehicle or scooter, e.g. provided on at least one end, and preferably both ends of the handlebars.

Preferably, the illumination means or novelty lighting effect may be powered by a self-contained battery operated unit.

Preferably, the illumination means comprises at least one LED.

The self-propelled or foot-propelled vehicle or scooter may comprise at least one audio device.

The at least one audio device may comprise a digital audio file player, e.g. having at least one digital audio file in an audio encoded format or a compressed format.

Preferably the digital audio file player may be a compressed digital audio file player.

The at least one audio device may advantageously comprise an MP3 player. The at least one audio device may be capable of playing one or more audio encoded formats, e.g. compressed formats, such as:
MPEG;
MPEG-1 Audio Layer 3 (or MP3);
MPEG-4;
MPEG-2;
MP3 and MP4 which are known standard formats;
WMA, WAV, AIFF, AU, PCM, M4P, MP4, M4A, AAC, HE-AAC, HE-AACv2, IFF, RIFF, BWF, RA;
WMA and WAV which are Microsoft standards;
Aiff which is an Apple Mac version;
M4P which is an i-tune standard;
AU which is UNIX/Sun version; and
PCM which is a CD standard or the like.

The at least one audio device may be capable of storing and playing one of a plurality of audio files, e.g. songs or music audio files.

The at least one audio device may comprise a first body, which may provide a memory or storage means.

The first body may provide a first loudspeaker.

The at least one audio device may comprise a second body, which may provide a second loudspeaker.

The first and/or second bodies may comprise means for attaching, preferably means for removably attaching, the first and/or second bodies to the vehicle.

The/each removable attachment means may comprise quick release and quick connection means, e.g. manually operable quick release and quick connection means.

The first and/or second bodies may be attached to, and preferably removably attachable to, the handlebars of the vehicle.

For example, in a preferred embodiment the first body may be attached to, and preferably removably attachable to, one end of handlebars of the vehicle.

In said preferred embodiment the second body may be attached to, and preferably removably attachable to, another end of handlebars of the vehicle.

In an alternative embodiment the first body may be attached to, and preferably removably attachable to, another part of the handlebars of the vehicle, e.g. at the front and/or substantially centrally.

In another alternative embodiment, the vehicle may be provided with a cradle adapted to receive the first body and/or an audio device and/or to which the first body and/or audio device may be removably attached.

When attached to the handlebars, the second body, e.g. comprising a second loudspeaker, may be electrically connected to the first body, e.g. by wiring provided in or running through the handlebars.

The at least one audio device may be powered by one or more battery(ies), e.g. provided within the first body and/or the second body.

The battery (ies) may, for example, be a lithium battery (ies).

The audio device may be provided on handlebars of the vehicle.

The at least one audio device may comprise means (such as a socket) for connecting earphones/earpiece/headphones thereto.

In such an arrangement, in use, when the earphones/earpiece/headphones are connected, an audio signal may be transmitted from memory means thereto, rather than to the loudspeaker(s).

The at least one audio device may comprise means for connecting the device to a computer apparatus, e.g. so as to store/transfer audio files (digital audio files), e.g. compressed digital audio files from the computer apparatus to the at least one audio device.

The means for connecting the device to earphones/earpiece/headphones and the means for connecting the device to a computer apparatus may comprise a single socket.

The means for removably attaching the first/second body from the vehicle may comprise at least one male portion or end on one of the vehicle or first/second body, and at least one corresponding female portion or skirt on the other of the first/second body or the vehicle. The male portion or end may be received within the female portion in a pushfit or interference fit.

The first body may be electrically connected to the wiring via a pin or socket on the first body and a corresponding socket or pin on the handlebars.

The second body may be electrically connectable to the wiring via a pin or socket on the second body and a corresponding socket or pin on the handlebars.

The means for removably attaching may also comprise a release button, e.g. on the first/second body, which may be spring biased.

It will be appreciated that the at least one audio device may be adapted to be used/usable when removed from the vehicle. For example, the at least one body may be used with or without the second body to play the audio file(s) via the loudspeaker(s)/earphones/earpiece(s).

The first/second body may include at least one and preferably a plurality of lights, e.g. light emitting diodes (LEDs), which, in use, may flash/illuminate in time with or be synchronised with audio signals, such as music, played by or output from the audio device.

The LEDs may be disposed around an outer facing end of the first/second body, e.g. behind a translucent/transparent end face.

The first and/or second body may each comprise a cylindrical body.

The first/second loudspeaker may be provided at one end of the respective first/second body, e.g. first/second cylindrical body.

Another end of the/each cylindrical body may be detachably attachable to the vehicle, e.g. the handlebars, e.g. a respective end of the handlebars.

The first body may be provided with control switches for the audio device, e.g. selected from play, pause, stop, forward and reverse. The first body may be provided with an on/off switch for the audio device. The control switches may be provided on an upper facing surface of the first cylindrical body. The on/off switch may be provided on a lower facing surface of the first body.

According to a second aspect of the present invention there is provided a self-propelled or foot-propelled vehicle or scooter according to the appended claims.

### BRIEF DESCRIPTION OF DRAWINGS

Embodiments of the present invention will now be described by way of example only, and with reference to the accompanying drawings, which are:

FIG. 1 an exploded perspective view from above, to one side and to the front of a scooter according to a first embodiment of the present invention;

FIG. 2 a partial exploded view of the scooter of FIG. 1;

FIG. 3 a circuit diagram of circuitry of the scooter of FIG. 1;

FIG. 4 a partial perspective view from above and to one side of part of a scooter according to a second embodiment of the present invention;

FIG. 5 an exploded schematic view of part of a platform of the scooter of FIG. 4;

FIG. 6 a perspective view of an underside of part of the platform of the scooter of FIG. 4;

FIG. 7 a top view of a printed circuit board of the scooter of FIG. 4;

FIG. 8 a perspective view of an upper portion of the platform of the scooter of FIG. 4;

FIG. 9 a perspective view from the front and to one side of a scooter comprising an audio device according to a third embodiment of the present invention;

FIG. 10 a detailed view of one end of a handlebar of the scooter of FIG. 9 providing a first body of an audio device;

FIG. 11 a detailed view of another end of the handlebar of the scooter of FIG. 9 providing a second body of the audio device;

FIG. 12 a detailed view of the first body of FIG. 10 connectable to earphones;

FIG. 13 a detailed view of the first body of FIG. 10 connectable to a USB cable, itself connectable to a computer apparatus (not shown); and

FIG. 14 a circuit diagram of the audio device of FIG. 9.

### DETAILED DESCRIPTION OF DRAWINGS

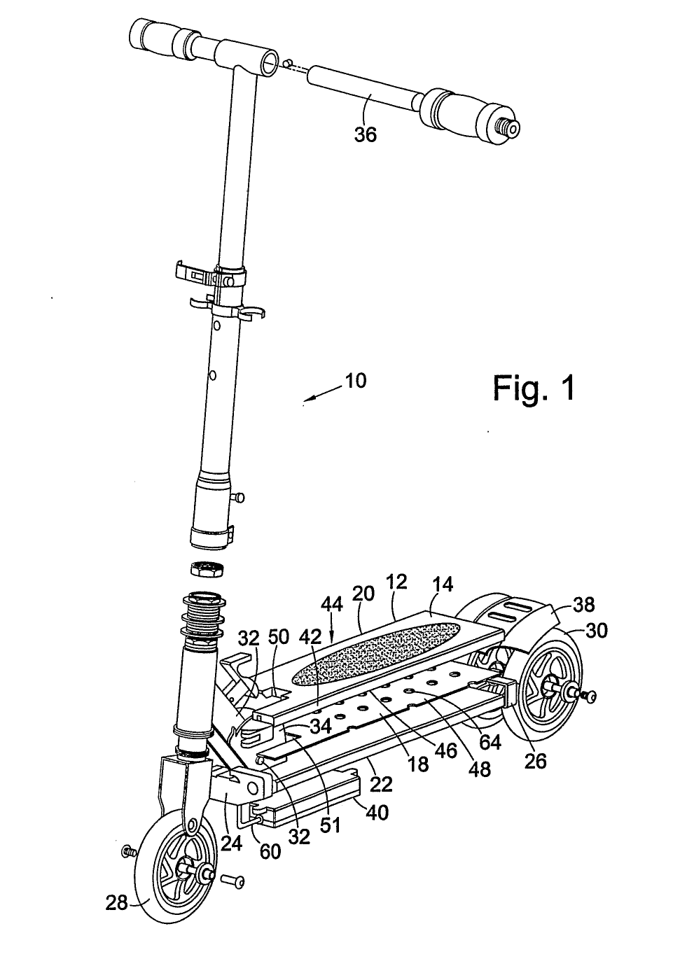

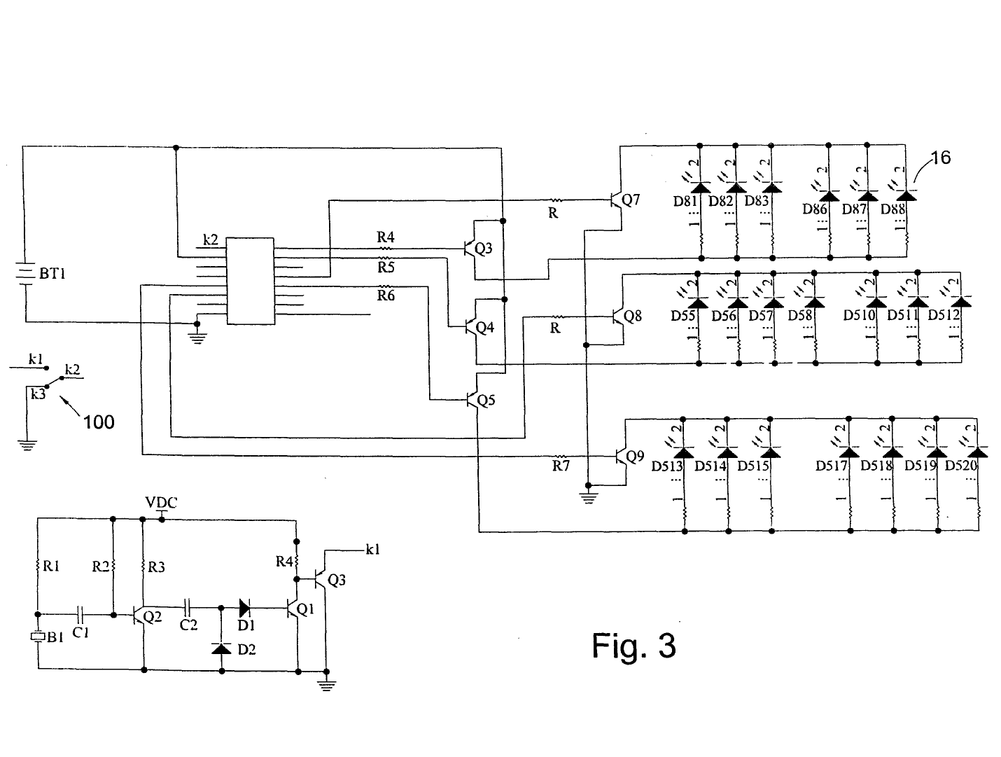

Referring initially to FIGS. 1 and 3, there is shown a vehicle comprising a scooter, generally designated 10, according to a first embodiment of the present invention. The scooter 10 comprises a platform or deck 12 having an upper surface or foot-plate 14, which in this embodiment is transparent—although such may be at least partly transparent and/or at least partly translucent.

The scooter 10 further comprises illumination means 16 which are mounted to a printed circuit board (PCB) 18 housed within the platform 12. The platform 12 comprises an upper portion 20, which in this embodiment is injection moulded from transparent plastic material, a lower portion 22, which in this embodiment is made from aluminium, such as extruded aluminium, a first end cap 24 and a second end cap 26, typically made from opaque plastic material.

In this embodiment, the scooter 10 is a collapsible microscooter having a single front wheel 28 and a pair of rear wheels 30, or in a modification, a single rear wheel. The scooter 10 lockably erectably collapses around a pivot or hinge 32 supported by a bracket 34. The scooter 10 also comprises handlebars 36 (shown on FIG. 1) and a rear brake 38.

In this preferred embodiment the scooter 10 is a collapsible scooter or “microscooter”. Alternatively in a less preferred modified embodiment the vehicle may be a skateboard.

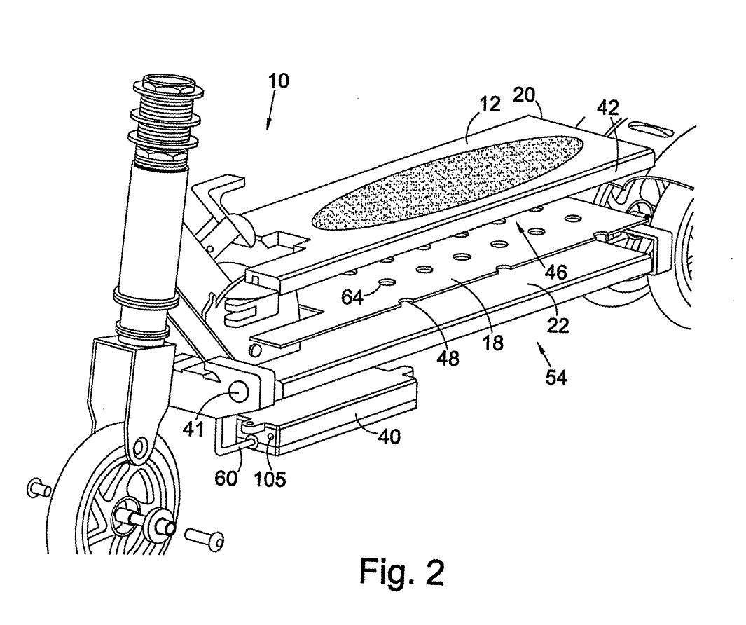

Referring now to FIG. 2, there is shown an exploded schematic view of part of the platform 12 of the scooter 10. The PCB 18 is sandwiched between the upper portion 20 of the platform 12 and the lower portion 22 of the platform 12. It will also be noted that the upper portion 20 has downwardly depending sides 42, 44, which at least partially wrap around or cover long sides 46, 48 of the PCB 18, and beneficially long sides of the lower portion 22.

The upper portion 20 is secured to the lower platform portion 22 by means of the first end cap 24 and the second end cap 26. The PCB 18 and the upper portion include cutouts 50,51, the purpose of which will be explained later.

The platform 12 further includes a control box 40 which includes batteries and circuitry 60 for controlling the illumination means 16. The control box 40 is connected to circuitry on the PCB 18 by means of a wire or wires 60. The control box 40 is secured in a channel 54 defined in a lower side of the lower portion 22 of the platform 12 by means of screws 56 which pass through brackets 58 on the control box 40. The control box 40 is electrically connected to a switch 41 (on the first end cap 24, e.g. a push button switch.

The control box 40 is positioned in the channel 54 defined in a lower side of the lower portion 22 of the platform 12. The wire 60 which connects the control box to the PCB 18 can be clearly seen. The lower portion 22 is, in this embodiment, an extruded section of aluminium.

The circuitry of the PCB 18 is typically adjacent the cut-out 50. Also included are a series of tracks which transmit signals to the illumination means 16, of which a number are indicated, in the form of surface mounted LEDs. The surface mounted LEDs, in this case are red and blue. It will, however, be appreciated that any available colour or colours may be provided.

The PCB 18 further includes a series of apertures 64. The purpose of these apertures 64 is the same as that in the second embodiment discussed hereinafter with reference to FIG. 5.

The control box 40 further include a switch means 100, which causes the illumination means 16 to illuminate, e.g. continuously, flash, and/or strobe in response to audio or acoustic input.

The scooter 10 comprises the illumination means 16 and switch means 100 for controlling the illumination means 100, wherein in one “on” position k1 the switch means 16 is audio or acoustically operated.

In position k1 the switch means 100 is activated by an audio input or signal such as an ambient voice, vocal input or preferably a musical signal. Alternatively the audio signal can be caused by striking the vehicle.

The switch means 100 and the illumination means 16 activate for as long as the audio signal lasts. The switch means 100 switches on when the audio signal starts and switches off when the audio signal stops. Thus the switch means 100 switches the illumination means 10 on and off in time with the audio signal, e.g. in time with music.

In a modification, the scooter 10 provides circuit means for upon activation operating the audio operated switch means 100 and/or the illumination means 10 for a predetermined length of time. Subsequent to the predetermined length of time the switch means 100 is deactivated.

The switch means 100 comprises an audio detection means 105 or microphone. The switch means 100 comprises a switch element controlled by the audio detection means. Beneficially the audio detection means 105 is located or positioned at or on the platform 10 of scooter.

The audio detection means 105 is located or positioned below the platform 12 of the scooter 12, e.g. between elongate sides or edge of the deck. In this embodiment the audio detection means 105 is provided on an end of the control box 40, e.g. on a front end thereof.

The switch means 100 also comprises switch 41. The switch 41 is provided on the platform 12, e.g. at a forward end thereof. The switch 41 has an “off” position, wherein the audio detection means 105 is off. The switch member 41 has a first “on” position, wherein the audio detection means 105 is on and the illumination means 16 controlled thereby as hereinbefore described. The switch member 41 has a second “on” position, wherein the illumination means 16 is illuminated in a predetermined manner, e.g. under control of control circuitry and independent of the audio detection means 105.

The upper portion 20 include pillars 66 which, when the platform 12 is assembled, extend through the apertures 64 in the PCB and engage the lower portion 22. The purpose of these pillars 66 is to transfer the weight of a user onto the lower portion 22 of the platform 12 without damaging the PCB 18, which is sandwiched between the upper and lower platform portions 20, 22.

Circuitry is located at either side of the cut-out 50 in the upper portion 20 of the platform 12 and the PCB 18. This cut-out 50 accommodates the bracket 34 which supports the pivot 32. The bracket 34 is welded to the lower portion 22 of the platform 12. This arrangement permits the circuitry to be at least to some degree, protected by the presence of the bracket 34, as the location of the bracket 34 acts to prevent a user's foot extending onto this part of the platform 12 and applying weight to the upper portion 20 in the vicinity of the circuitry 52, which may damage the circuitry 52.

FIG. 3 shows a circuit diagram for the PCB 18.

The rear brake 38 is resiliently biased away from the rear wheels 30. However, in use, a force, may be applied e.g. via a foot of a user, to the brake 38 to cause first and second suitably shaped portions of the brake 38 to frictionally engage the rear wheels 30.

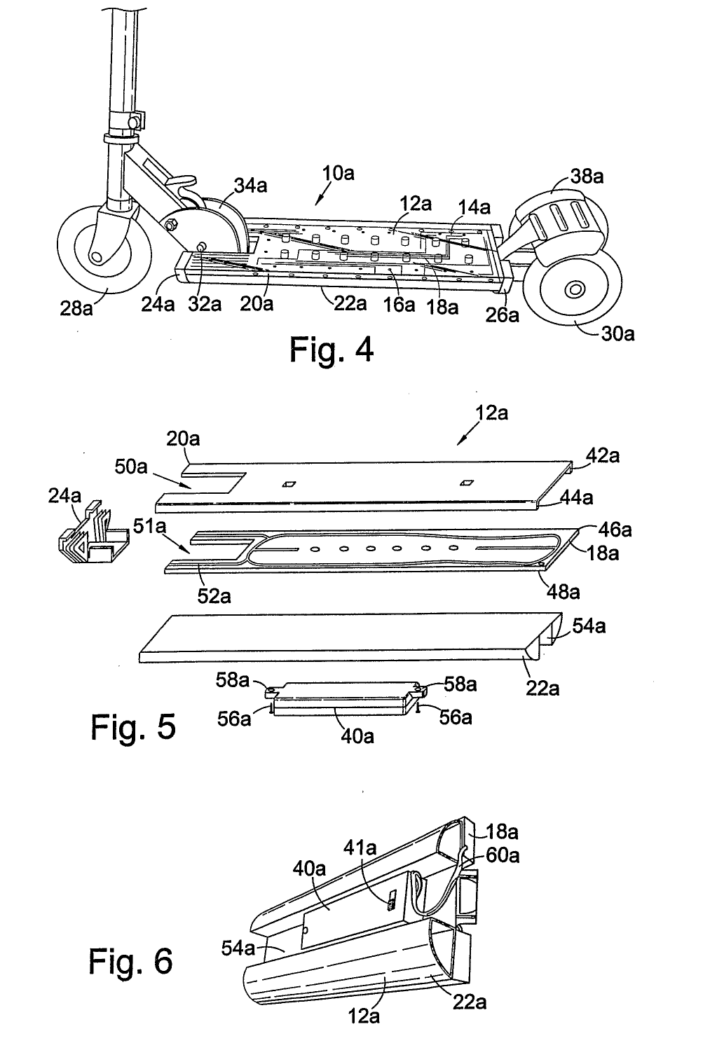

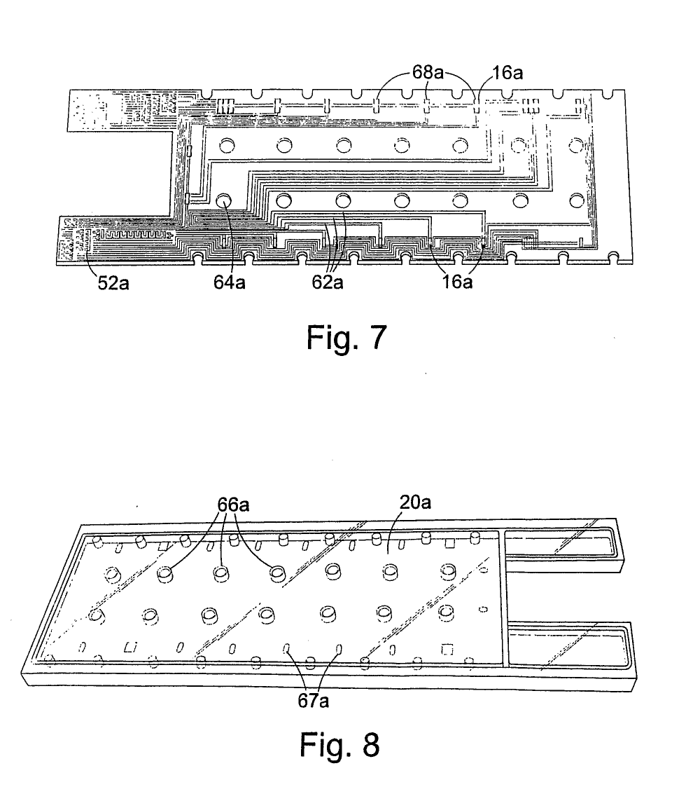

Referring now to FIGS. 4 to 8 there is shown a scooter, generally designated 10a, according to a second embodiment of the present invention. The scooter 10a is similar to the scooter 10 of the first embodiment, like parts being denoted by like numerals, but suffixed “a”.

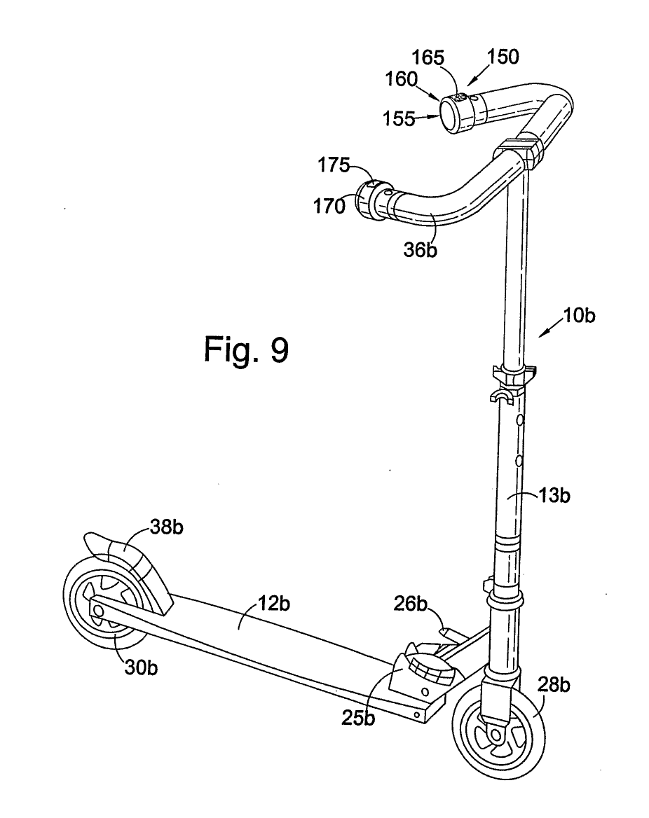

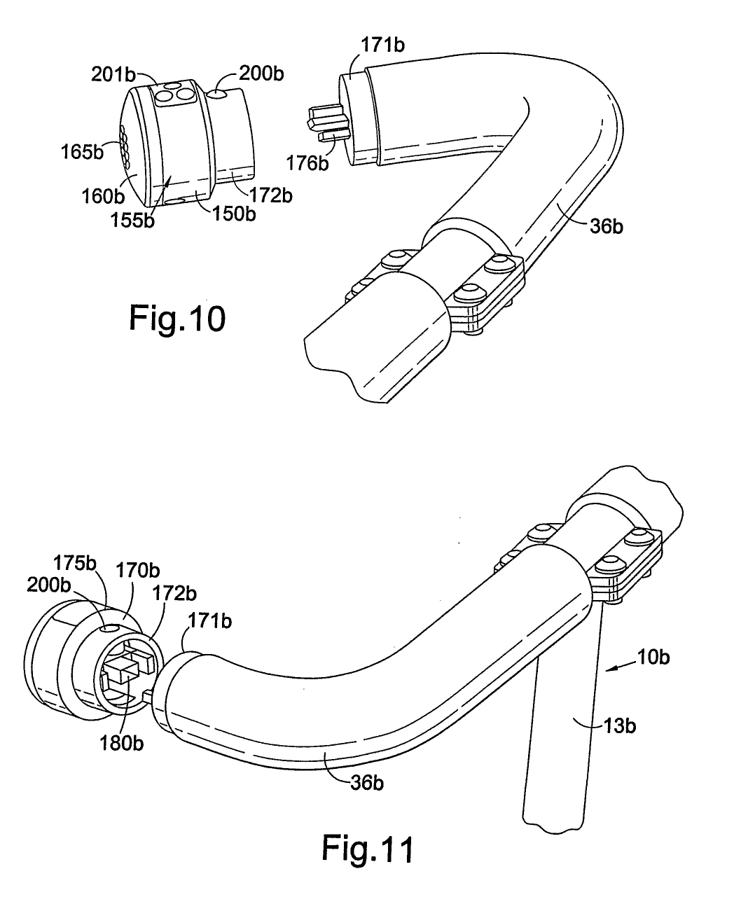

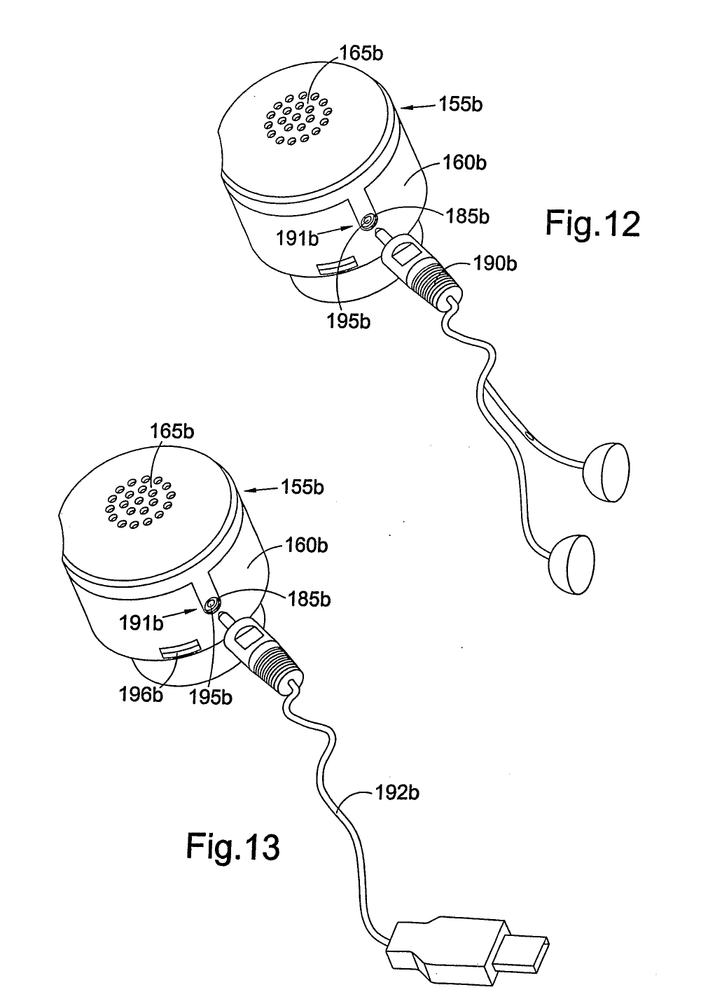

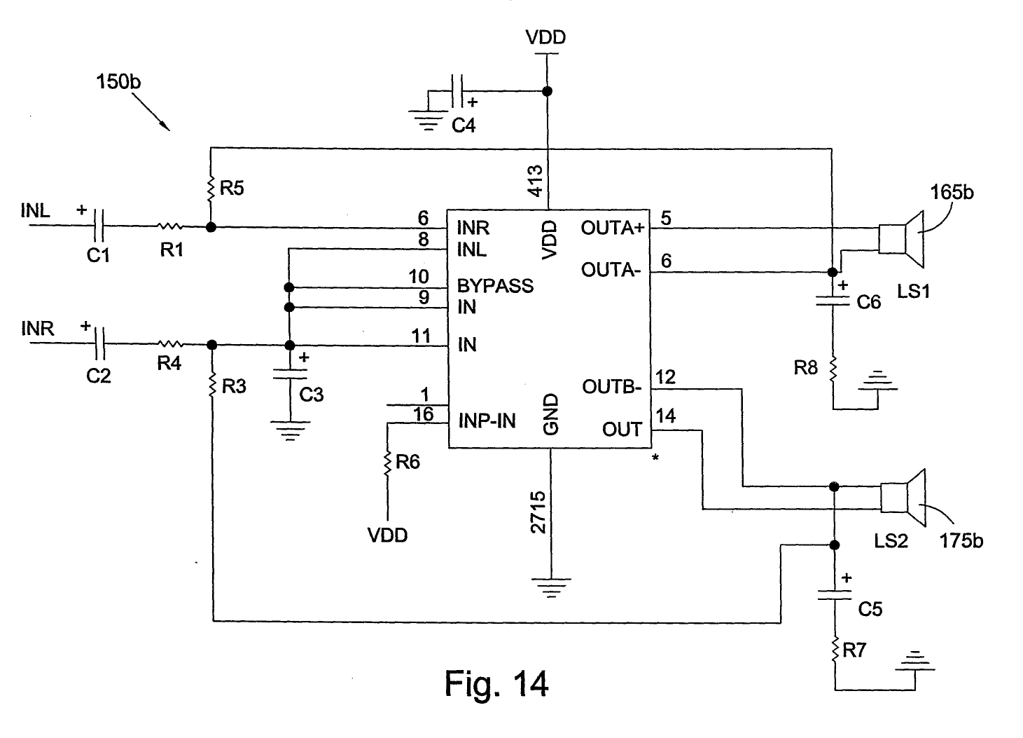

Referring now to FIGS. 9 to 14 there is shown a scooter, generally designated 10b, according to a third embodiment of the present invention. The scooter 10b is similar to the scooter 10 of the first embodiment, like parts being denoted by like numerals, but suffixed “b”.

The scooter 10b comprises first and second wheels 28b,30b, platform or footplate 12b, height adjustable steering column 13b, handlebars 36b, rear brake 38b, and hingable locking mechanism 25b for collapsing the scooter 10b, and including lever 26b.

The scooter 10b comprises at least one audio device 150b. The at least one audio device 150b comprises a digital audio file player, and advantageously a compressed digital audio file player. In this preferred implementation the at least one audio device 150b comprises an MP3 player 155. In an alternative implementation the at least one audio device 150b may comprise a digital audio file player capable of playing one or more additional or alternative formats. The at least one audio device 150b may additionally or alternatively comprise a mobile/cellular telephone and/or radio receiver.

The at least one audio device 150b comprises a first body 160b, which is provided with a memory or storage means (not shown). The first body 160b is also provided with a first loudspeaker 165b

The at least one audio device 150b also comprises a second body 170b which provides a second loudspeaker 175b.

The first and/or second bodies 160b,170b each comprise means for removably attaching the first and/or second bodies 160b,170b to the scooter 10b. In this embodiment the first and/or bodies 160b,170b are removably attachable to the handlebars 130b of the scooter 10b. The first body 160b is removably attachable to one end of the handlebars 36b. The second body 170b is removably attachable to another end of the handlebars 36b.

In this beneficial implementation the means for removably attaching comprises quick release connection means, as will hereinafter be described in greater detail. In an alternative embodiment the first body 160b may be removably attachable to another part of the handlebars 36b, e.g. at the front and/or substantially centrally. In such an alternative embodiment the second body may optionally not be provided.

In another alternative embodiment, the scooter 10b is provided with a cradle adapted to removably receive the audio device 150b, and having connections for connecting the audio device 150b at least to the speakers 165b,175b. The cradle may be secured to the handlebars 130b, and may grip the audio device 150b. The cradle is typically similar to the type used in automobiles to hold telephones.

When attached to the handlebars 130b the second body 170b, e.g. second loudspeaker, is electrically connected to the first body 160b, e.g. by wiring (not shown) running through the handlebars 130b.

The at least one audio device 150b is powered by one or more batteries (not shown), e.g. provided within the first body 160b and/or the second body 170b. The one or more batteries may, for example, be a lithium battery.

The at least one audio device 150b comprises means 185b (such as a socket) for connecting earphones/earpiece/headphones 190b thereto. In such an arrangement, in use, when the earphones/earpiece/headphones 190b are connected an audio signal is transmitted from memory means thereto, rather than to the loudspeaker(s) 165b,175b.

The at least one audio device 150b also comprises means 191b (such as a socket) for connecting the audio device 150b to a computer apparatus (not shown), e.g. so as to transfer audio files from the computer apparatus to be stored on memory means of the at least one audio device 150b, e.g. via a USB cable 192b. In this embodiment the means 185b for connecting the audio device 150b to earphones/earpiece/headphones and the means 191b for connecting the device to a computer apparatus comprise a single socket 195b. Alternatively, in a modified embodiment there is provided a separate USB socket 196b.

The means for removably attaching the first/second body 160b/170b from the scooter 10b comprise at least one male portion or pin 171b on one of the scooter 10b or first/second body 160b/170b, and at least one corresponding female portion or skirt 72 on the other of the first/second body 160b/170b or the scooter 10b. As can be seen, the male portion 171b receives the female portion 172b in a push fit or interference fit. The means for removably attaching also comprises a release button 200b, e.g. on the first/second body 160b/170b, which is typically spring biased.

The first body 160b is electrically connectable to the wiring via at least one pin 176b or socket 180b on the first body 160b, and a corresponding socket 180b or pin 176b on the handlebars 130b. The second body 170b is similarly electrically connectable to the wiring via a pin or socket on the second body 170b, and a corresponding socket or pin on the handlebars 130b. The release button 100b is typically spring biased and controls an engaging member (not shown), which engages with the handlebars 130b so as to releasably secure the first/second body 160b/170b to the scooter 10b. It will be appreciated that such means for removable attachment comprises quick release and quick connection means.

From the foregoing it will be appreciated that the at least one audio device 150b may be adapted to be used/usable when removed from the scooter 10b.

In this embodiment the first and/or second body 160b/170b each comprise a cylindrical body. The first/second loudspeaker 165b,175b is provided at one end of the respective first/second cylindrical body 160b/170b.

Another end of the/each cylindrical body 160b/170b is detachably attachable to the scooter 10b, e.g. the handlebars 130b, e.g. a respective end of the handlebars as hereinbefore described.

The first body 160b is provided with control switches 201b for the audio device, e.g. selected from play, pause, stop (not shown), for the audio device 5. The control switches 201b are conveniently provided on an upper facing surface of the first cylindrical body 160b. The on/off switch is conveniently provided on a lower facing surface of the cylindrical body 160b.

It will be understood that the foregoing embodiments of the present invention are given for illustrative purposes only, and that various modifications and improvements may be made to the scooter described herein without departing from the scope of the invention. For example, although the platform of the first embodiment is in part transparent, it could be in part translucent to defuse the light from the surface mounted LEDs and provide a different visual effect.

The surface mounted LEDs can be of any colour or a combination of different colours. The vibration switch could alternatively or additionally be a weight sensor.

It will be appreciated that the preferred embodiments of the scooters hereinbefore described are advantageously collapsible “microscooters”. However, it will be appreciated that the lighting effect described may be provided on other types of scooters, e.g. non-collapsible scooters, or alternatively skateboards or other foot-propelled vehicles having a platform or deck and two or more wheels.

1. A self-propelled or foot-propelled vehicle or scooter, comprising at least one illumination means and a switch means for controlling the at least one illumination means, wherein the switch means is audio or acoustically operated or activated.

2. A self-propelled or foot-propelled vehicle or scooter as claimed in claim 1, wherein the vehicle is a scooter, such as a collapsible scooter or microscooter.

3. A self-propelled or foot-propelled vehicle or scooter as claimed in claim 1, wherein the vehicle is a skateboard.

4. A self-propelled or foot-propelled vehicle or scooter as claimed in claim 1, wherein the switch means is activated by an audio or acoustic input or signal, such as an ambient voice, vocal or a musical signal or by an audio or acoustic input or signal caused by striking the vehicle.

5. A self-propelled or foot-propelled vehicle or scooter as claimed in claim 1, wherein the switch means comprises an audio or acoustic detection means optionally provided on a platform of the scooter, such as on an underside thereof, such as a recessed underside.

6. A self-propelled or foot-propelled vehicle or scooter as claimed in claim 1, wherein the illumination means are provided on a platform.

7. A self-propelled or foot-propelled vehicle or scooter as claimed in claim 1, wherein the vehicle or scooter comprises or provides at least one audio (player) device, such as a digital audio file player, which is optionally detachably attachable to the scooter, such as handlebars thereof.

8. A self-propelled or foot-propelled vehicle or scooter as claimed in claim 1, wherein the switch means and/or illumination means is activated only for a period as long as the audio input or signal lasts.

9. A self-propelled or foot-propelled vehicle or scooter as claimed in claim 1, wherein the switch means switches the illumination means on and/or off in time with or in synchronisation with the audio or acoustic input or signal.

10. A self-propelled or foot-propelled vehicle or scooter as claimed in claim 1, wherein the vehicle or scooter provides means for operating the switch means and/or the illumination means for a predetermined length of time upon operation or activation, such that subsequent to the predetermined length of time the switch means is deactivated.

11. A self-propelled or foot-propelled vehicle or scooter as claimed in claim 1, wherein the switch means comprises an audio detection means or microphone and a switch element controlled by the audio detection means.

12. A self-propelled or foot-propelled vehicle or scooter as claimed in claim 11, wherein the audio detection means is located or positioned at or on a platform or deck of the vehicle or scooter.

13. A self-propelled or toot-propelled vehicle or scooter as claimed in claim 11, wherein the audio detection means is located or positioned below the platform or deck of the vehicle or scooter, and optionally in a recess below the platform or deck or between substantially parallel elongate downwardly depending sides or edges of the platform or deck.

14. A self-propelled or foot-propelled vehicle or scooter as claimed in claim 11, wherein the audio detection means is located or positioned on or in a control box or in an enclosure.

15. A self-propelled or foot-propelled vehicle or scooter as claimed in claim 14, wherein the audio detection means is provided on an end of the enclosure, and the switch element is provided within the control box or enclosure.

16. A self-propelled or foot-propelled vehicle or scooter as claimed in claim 1, wherein the switch means comprises a switch member.

17. A self-propelled or foot-propelled vehicle or scooter as claimed in claim 16, wherein the switch member is provided on a/the platform or deck, optionally at a forward end thereof.

18. A self-propelled or foot-propelled vehicle or scooter as claimed in claim 1, wherein the switch member has an off position wherein an audio detection means is off.

19. A self-propelled or foot-propelled vehicle or scooter as claimed in claim 16, wherein the switch member has a first on position, wherein an audio detection means is on.

20. A self-propelled or foot-propelled vehicle or scooter as claimed in claim 16, wherein the switch member has a second on position, wherein the illumination means is illuminated in a predetermined manner, such as under control of control circuitry and independent of a/the audio detection means.

21. A self-propelled or foot-propelled vehicle or scooter as claimed in claim 1, wherein the vehicle or scooter comprises a platform for supporting a user, the platform comprising the illumination means, the illumination means being provided on at least one of on or adjacent an upper surface thereof and along or adjacent a side edge(s) thereof.

22. A self-propelled or foot-propelled vehicle or scooter as claimed in claim 1, wherein the vehicle or scooter has a platform for supporting a user, the platform being at least part transparent or translucent.

23. A self-propelled or foot-propelled vehicle or scooter as claimed in claim 22, wherein at least part of the platform comprises a metal or metallic material.

24. A self-propelled or foot-propelled vehicle or scooter as claimed in claim 22, wherein at least part of the platform comprises a polymeric or plastics material.

25. A self-propelled or foot-propelled vehicle or scooter as claimed in claim 1, wherein the illumination means comprises at least one or a plurality of light sources, such as light emitting diodes.

26. A self-propelled or foot-propelled vehicle or scooter as claimed in claim 1, wherein the vehicle or scooter comprises at least one audio device.

27. A self-propelled or foot-propelled vehicle or scooter as claimed in claim 26, wherein the at least one audio device comprises a digital audio file player, optionally having at least one digital audio file in an audio encoded form or a compressed format.

28. A self-propelled or foot-propelled vehicle or scooter as claimed in claim 1, wherein the vehicle or scooter comprises at least one audio device comprising a digital audio file player, the device comprising a first body providing a loudspeaker, the first body comprising means for removably attaching or removably receiving the first body to the vehicle or scooter.

29. A self-propelled or foot-propelled vehicle or scooter as claimed in claim 26, wherein the at least one audio device is capable of storing and playing one of a plurality of audio files, such as songs or music audio files.

30. A self-propelled or foot-propelled vehicle or scooter as claimed in claim 26, wherein the at least one audio device comprises a first body which provides a memory or storage means and a first loudspeaker.

31. A self-propelled or foot-propelled vehicle or scooter as claimed in claim 30, wherein the at least one audio device comprises a second body, which provides a second loudspeaker.

32. A self-propelled or foot-propelled vehicle or scooter as claimed in claim 29, wherein the first body and optional second each comprise means for removably attaching the respective body to the vehicle.

33. A self-propelled or foot-propelled vehicle or scooter as claimed in claim 32, wherein the or each removable attachment means comprises quick release and quick connection means.

34. A self-propelled or foot-propelled vehicle or scooter as claimed in claim 30, wherein the first body and an optional second body are removably attachable to handlebars of the vehicle.

35. A vehicle, such as a scooter, comprising audio or acoustically operated switch means for controlling illumination means.

36. (canceled)

37. A self-propelled or foot-propelled vehicle or scooter as claimed in claim 31, wherein the first body and an optional second body are removably attachable to handlebars of the vehicle.

38. A self-propelled or foot-propelled vehicle or scooter as claimed in claim 32, wherein the first body and an optional second body are removably attachable to handlebars of the vehicle.

39. A self-propelled or foot-propelled vehicle or scooter as claimed in claim 33, wherein the first body and an optional second body are removably attachable to handlebars of the vehicle.
